(19) United States
(12) Patent Application Publication
(10) Pub. No.: US 2002/0069141 A1
(43) Pub. Date: Jun. 6, 2002

(54) Method for managing physical distribution with returnable containers

(75) Inventors: So Kawamura, Kasugai City (JP); Shigeki Urai, Nagoya City (JP); Isao Agekura, Toyonaka City (JP); Osamu Kimizuka, Toyoake City (JP)

Correspondence Address: Charles A. Wendel, PARKHURST & WENDEL, L.L.P., Suite 210, 1421 Prince Street, Alexandria, VA, 22314-2805, US

(73) Assignee: NGK INSULATORS, LTD.

(21) Appl. No.: 09/982,991

(22) Filed: Oct. 22, 2001

(30) Foreign Application Priority Data
Oct. 25, 2000 (JP) 2000-325534

(51) Int. Cl. G06F 17/60

(52) U.S. Cl. 705/28

(57) ABSTRACT

A method for managing physical distribution of products and returnable containers in which a first party send at least one product in a returnable container to a second party upon a request from the merchandiser to ship the products, and the second party sends back the returnable container to the first party is provided. The method includes receiving a request to shop at least one product from the merchandiser, determining a product inventory balance based on inventory information about the products and the request to shop at least one product, and based on the product inventory balance determination sending a product-shipping notice to the first party, and determining a returnable containers inventory balances based on inventory information about the returnable containers and the request to ship at least one product, and based on the returnable container inventory balance determination sending a returnable container-returning notice to the second party.

### BACKGROUND OF THE INVENTION

1. Field of the Invention

The present invention relates to an improved method for managing physical distribution of products and returnable containers in which a first party ships at least one product packed in a returnable container to a second party upon a request from the merchandiser to ship the at least one product, and the merchandiser sends back the returnable container to the manufacturer.

2. Description of the Related Art

A method for managing physical distribution of products and containers in which a manufacturer ships at least one product to a merchandiser upon a request from the merchandiser to ship the products has been conventionally employed in various kinds of industries. In recent years, an issue of recycling materials has been discussed, and a movement of reusing containers used in shipping at least one product has become larger. As means for this sake, a physical distribution method in which returnable containers are used as the containers, the manufacturer ships the products packed in the returnable containers to the merchandiser upon the request from the merchandiser to ship the products and the merchandiser sends back the returnable containers of the received products to the manufacturer begins to be implemented.

The aforementioned physical distribution method using the returnable containers is effective in terms of recycling materials since the method can reuse the containers for packing the products which used to be thrown away. However, in this method, since the products should be always packed in the returnable containers, such a problem has been caused that the products cannot be sent unless the distribution of the returnable containers is well managed. That is, when the manufacturer intended to ship the products upon the request from the merchandiser to ship the products, the products could not be shipped without sufficient number of the returnable containers existing at the manufacture's side. In addition, as is the case with the conventional physical distribution methods, there was a difficulty in managing the inventory of the product at the manufacture's side since the request from the merchandiser to ship the products was in flux, especially when two or more merchandisers exist.

### SUMMARY OF THE INVENTION

It is an object of the present invention to solve the above problems and to provide a physical distribution method which enables inventories of the returnable containers and the products to be effectively managed.

A physical distribution method of the present invention is a method for managing physical distribution of products and returnable containers in which a manufacture (first party) ships at least one products packed in a returnable container to a merchandiser (second party) upon a request from the merchandiser to ship the products and the merchandiser sends back the returnable containers to the manufacturer, said method comprising the steps of:

receiving a request from the merchandiser to ship at least one product;

determining a product inventory balance based on inventory information about the products and the request to ship at least one product, and based on the product inventory balance determination sending a product-shipping notice to the manufacturer; and

determining a returnable container inventory balances based on inventory information about the returnable containers and the received request to ship at least one product, and based on the returnable container inventory balance determination sending a returnable container-returning notice to the merchandiser.

The merchandiser in the present invention is not limited to a retailer of the final products, but includes receivers of the products from the manufacturer, such as a wholesaler, an assembling plant runner, a processing plant runner or the like. The manufacturer in the present invention is not limited to a producer of the final products, but includes senders of the products to the merchandiser, such as a wholesaler, a sections plant, a raw material producer or the like.

In the present invention, inventories of the returnable containers and products can be effectively managed by, in response to the product-shipping request of the merchandiser, calculating a product inventory balance based on the inventory information about the products to send the product-shipping notice to the manufacturer as well as calculating a returnable container inventory balances based on the inventory information about the returnable containers to send a returnable container-returning notice to the merchandiser.

In a preferred embodiment of the present invention, the manufacturer, the merchandiser and a server for storing inventory information databases of the products and the returnable containers are interconnected via a computer network, and

A. the merchandiser transmitting the request to ship at least one product to the server via the computer network;

B. the server, in response to the received request,

a) calculating product inventory balance from a desired number of stock based on the request to ship at least one product and the inventory information database of the products and transmitting the product-shipping notice to the manufacturer via the computer network to urge the manufacturer to make the products if the stock of the products is below a predetermined level;

b) calculating returnable container inventory balance from a desired number of stock based on the inventory information database of the returnable containers and transmitting the returnable container-returning notice to the merchandiser via the computer network to urge the merchandiser to return the returnable-containers if the stock of the returnable containers is below a predetermined level; and

c) transmitting the request to ship at least one product to the manufacturer via the computer network;

C. the manufacturer, in response to the received request to ship at least one product, ships the products packed in the returnable container to the merchandiser.

In another preferred embodiment of the present invention, the actual inventory of the products is adjusted to a predetermined level by the manufacturer based on the manufacturer receiving the product-shipping notice so that the actual inventory after the shipment may be at a desired level. The returnable containers are sent to the manufacturer by the merchandiser based on the merchandiser receiving the returnable container-returning notice so that the actual inventory at the manufacturer's side may be at a desired level. Further,

A. the manufacturer transmitting to the server via the computer network data indicating a number of the products shipped from the manufacturer, and

B. the server renewing the inventory information database of the products based on the number of shipped products received by the merchandiser. Furthermore,

A. the merchandiser transmitting to the server via the computer network data indicating a number of the returnable containers returned from the merchandiser, and

B. the server renewing the inventory information database of the returnable containers based on the number of returnable containers returned to the manufacturer.

Both of the above preferred embodiments of the present invention can more effectively manage the inventory of the returnable containers and the products in the physical distribution-managing method according to the present invention.

### BRIEF DESCRIPTION OF THE DRAWINGS

For the better understanding of the present invention, reference is made to the accompanying drawings, in which:

FIG. 1 is a conceptual diagram showing a configuration of a computer system in the physical distribution-managing method in accordance with one preferred embodiment of the present invention;

FIG. 2 is a flow diagram of the information about the physical distribution in the physical distribution-managing method in accordance with one preferred embodiment of the present invention; and

FIG. 3 is a flow chart illustrating the procedures carried out in the physical distribution-managing method in accordance with one preferred embodiment of the present invention.

### DETAILED DESCRIPTION OF THE INVENTION

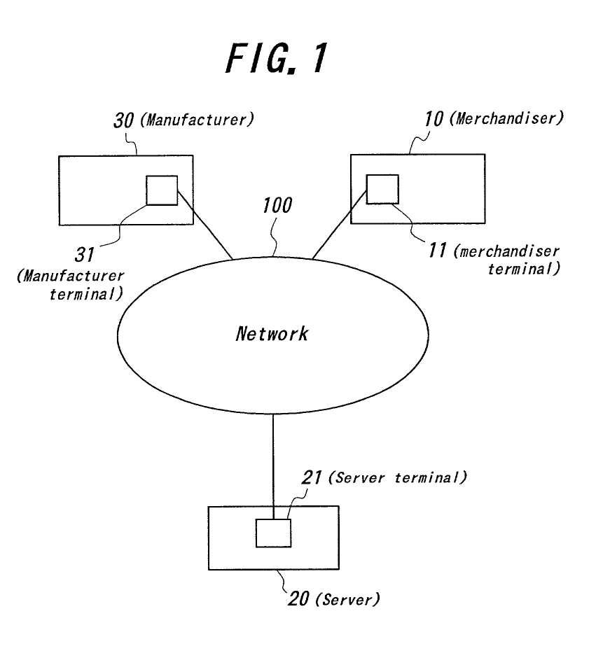

FIG. 1 is a conceptual diagram showing a configuration of a computer system in the physical distribution method in accordance with one preferred embodiment of the present invention. In this embodiment, the merchandiser 10, the server 20 and the manufacturer 30 are connected to a computer network 100 such as the Internet via a merchandiser terminal 11, a server terminal 21 and a manufacturer terminal 31, respectively. As the merchandiser terminal 11 and the manufacturer terminal 31, generally available personal computers can be used. In this figure, only an example having one merchandiser 10 and one manufacturer 30 is illustrated, however, the system may consist of two or more merchandisers 10 and two or more manufacturers 30 being connected via the computer network 100 in the same configuration.

A case where Company A is in Japan as a merchandiser, Company B is in Japan and has the server 20, and Company C is in Thailand as a manufacturer 30 will be now described as a specific example of the physical distribution method according to the present invention as shown in FIG. 1. In this case, Company A of the merchandiser 10 in Japan sells aluminum wheels, Company C of the manufacturer 30 in Thailand manufactures the products, packs the products in the returnable containers so-called dunnages, and then sends the packed products to Company A, while Company A sends back the used dunnages to Company C.

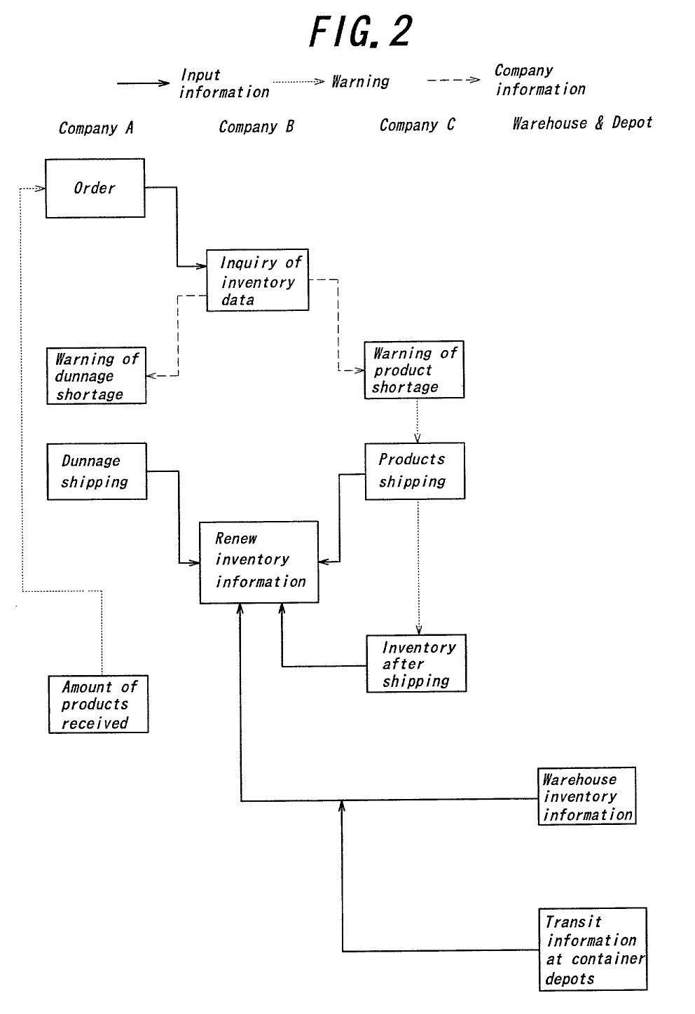

FIG. 2 is a flow diagram of the information about the physical distribution in the above physical distribution-managing method in accordance with one preferred embodiment of the present invention. In this embodiment, Company A of the merchandiser 10 sends a purchase order, which also acts as a request to ship at least one product, to the server 20 via the computer network 100 while referring to the number of incoming products. When Company A receives a notice of dunnage shortage from the server 20 via the computer network 100, Company A sends back the dunnages to Company C of the manufacturer 30, and sends the number of the outgoing dunnages to the server 20 via the computer network 100. Company C of the manufacturer 30 ships the products in response to the request to ship at least one product sent by Company A of the merchandiser 10 via the server 20 and the computer network 100. When Company C receives a notice of product shortage from the server 20 via the computer network 100, Company C adjusts the inventory of the products.

Further, the server 20 compares the request to ship at least one product from Company A of the merchandiser 10 to inventory data comprising a product inventory database and a dunnage inventory database. When the product inventory is below a predetermined value, the server 20 sends a notice of product shortage as a product-shipping notice to Company C of the manufacturer 30. When the dunnage inventory is below a predetermined value, the server 20 sends a notice of dunnage shortage to Company A of the merchandiser 10. Further, the server 20 renews the above inventory data based on the dunnage inventory from Company A of the merchandiser 10 and the product inventory from Company C of the manufacturer 30. Information such as the inventory stocked at the warehouses and the depots or transit states at the container depots is preferably taken into consideration of renewing the inventory data.

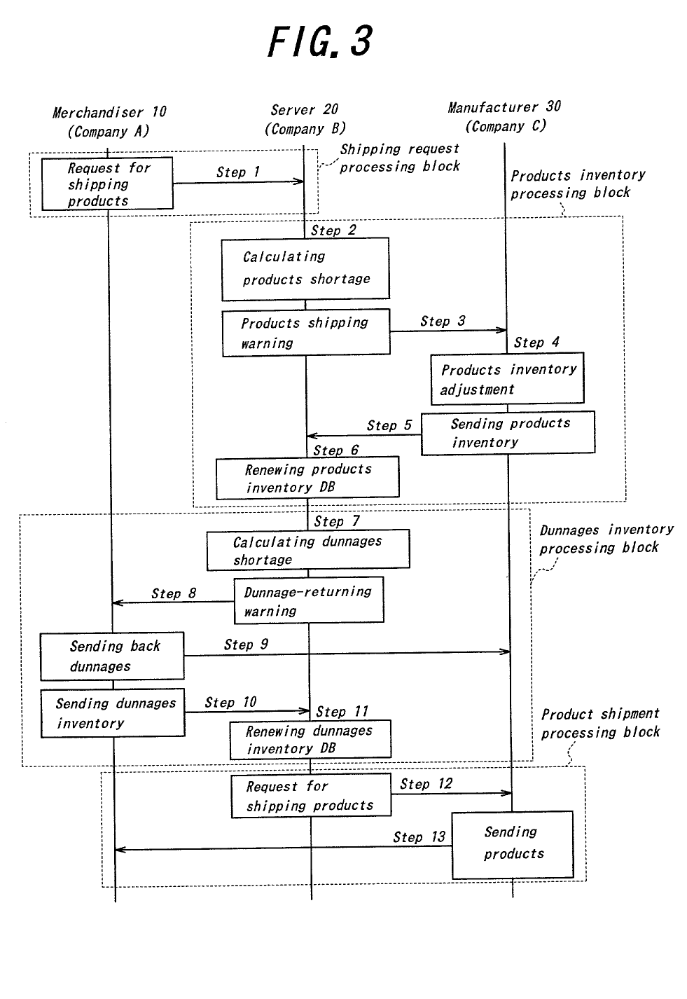

Procedures among the merchandiser 10, the server 20 and the manufacturer 30 in the physical distribution-managing system according to the present invention will be discussed in the next. FIG. 3 is a flow chart illustrating the procedures carried out in the physical distribution method according to the present invention shown in FIGS. 1 and 2. With reference to FIG. 3, the physical distribution system according to the present invention will be described.

Company A of the merchandiser 10 sends the request to ship at least one product to the server 20 via the computer network 100 using the merchandiser terminal 11 (step 1). The request to ship at least one product is made by the merchandiser 10 inputting, for example, product numbers, quantities, date and/or destinations on a monthly basis to the merchandiser terminal 11.

Then, the server 20 calculates a difference between an actual number of products in stock and a desired number of stock based on the request to ship at least one product and the inventory information database of the products (step 2). As a result of the calculation, if the product inventory is found to be below a predetermined level, the product-shipping notice is sent from the server terminal 21 to Company C of the manufacturer 30 via the computer network 100 to urge the manufacturer to make available the products (step 3). The product-shipping notice is effected by notifying of, for example, product numbers, quantities, date and/or destinations on a weekly basis. When Company C of the manufacturer 30 receives the product-shipping notice, Company C adjusts the product inventory after the shipment to be at a predetermined level, for example, by manufacturing a deficit in the products (step 4). Company C sends the product inventory data from the manufacturer terminal 31 to the server 20 via the computer network 100 (step 5). Then, the server 20 renews the inventory information database of the products based on the received product inventory data (step 6).

Then, the server 20 also calculates a balance between an actual number of dunnages in stock and a desired number of stock based on the request to ship at least one product and the inventory information database of the dunnage (step 7). As a result of the calculation, if the dunnage inventory is found to be below a predetermined level, the dunnage-returning notice is sent from the server terminal 21 to Company C of the manufacturer 30 via the computer network 100 to urge the merchandiser to send back the dunnage (step 8). When Company A of the merchandiser 10 receives the dunnage-returning notice, Company A sends back the dunnages to Company C of the manufacturer 30 so that the inventory of the dunnages at the Company C of the manufacturer 30 is at a desired level (step 9). Company C of the merchandiser 10 sends the dunnage inventory data from the merchandiser terminal 11 to the server 20 via the computer network 100 (step 10). Then, the server 20 renews the inventory information database of the dunnage based on the received dunnage inventory data (step 11).

The server 20 sends the request to ship at least one product from the server terminal 21 to Company C of the manufacturer 30 via the computer network 100 (step 12). Finally, Company C of the manufacturer 30 sends aluminum wheels as the products packed in the dunnages to Company A of the merchandiser 10 (step 13).

The flow chart of the physical distribution system according to the present invention shown in FIG. 3 illustrates only one preferred embodiment, and the present invention can be achieved, for example, by interchanging the steps 2-6 (product inventory-processing block) with the steps 7-11 (dunnage inventory-processing block). The present invention can also be achieved by implementing the request to ship at least one product from the server 10 to the manufacturer 30 (step 12) and the shipment of the products from the manufacturer 30 to the merchandiser 10 (step 13), for example, between the steps 1 and 2.

In the aforementioned embodiments, the system of the server 20 is not exemplified, but generally available server systems such as MMT Delivery Express System (Meiko Trans Co., Ltd.) may be preferably used.

As clearly shown in the above description, according to the present invention, the inventories of the returnable containers and the products can be effectively managed since the deficit of the products is calculated based on the inventory information about the products to alert the manufacturer to the product-shipping notice as well as the deficit of the returnable containers being calculated based on the inventory information about the returnable containers in response to the request from the merchandiser to ship the products.

What is claimed is:

1. A method for managing physical distribution of products and returnable containers in which first party ships at least one products packed in a returnable container to a second party in response to a request from the second party to ship the at least one product, and the second party sends back the returnable container to the first party, said method comprising:
receiving a request from a second party to ship at least one product;
determining a product inventory balance based on inventory information about said products and the request to ship at least one product, and based on said product inventory balance determination sending a product-shipping notice to the first party; and
determining a returnable container inventory balance based on inventory information about the returnable containers and the received request to ship at least one product, and based on said returnable container inventory balance determination sending a returnable container-returning notice to the second party.

2. The method for managing physical distribution of products and returnable containers as set forth in claim 1, wherein the first party, the second party and a server for storing inventory information databases of the products and the returnable containers are interconnected via a computer network,
said receiving a request to ship said at least one product comprises transmitting the request from the second party to the server via the computer network,
said determining a product inventory balance comprises calculating the difference between an actual inventory of the products and a desired inventory level of the products based on the request to ship at least one product and the inventory information database of the products;
said sending said product-shipping notice to the first party comprises sending said notice via the computer network when said product inventory balance is below a first predetermined level;
said determining a returnable container inventory balance comprises calculating the difference between an actual inventory of the returnable containers and a desired inventory level of the returnable containers based on the inventory information database of the returnable containers; and
said sending said returnable container-returning notice to the second party comprises sending said notice via the computer network when said returnable container inventory balance is below a second predetermined level;
said method further comprising:
transmitting the request to ship at least one product to the first party via the computer network; and
shipping at least one product packed in the returnable container from the first party to the second party in response to the received request to ship at least one product.

3. The method for managing physical distribution of products and returnable containers as set forth in claim 2, further comprising:
adjusting by the first party said actual inventory of the products to a third predetermined level based on the first party receiving the product-shipping notice so that the actual inventory after the shipment may be at a desired level.

4. The method for managing physical distribution of products and returnable containers as set forth in claim 2, further comprising:
sending by the second party the returnable containers to the first party based on the second party receiving the returnable container-returning notice.

5. The method for managing physical distribution of products and returnable containers as set forth in claim 3, further comprising:
transmitting to the server via the computer network data indicating a number of products shipped from the first party, and
renewing the inventory information database of the products on the server based on the number of shipped products received by the second party.

6. The method for managing physical distribution of products and returnable containers as set forth in claim 4, further comprising:
transmitting to the server via the computer network data indicating the number of returnable containers returned from the second, and
renewing the inventory information database of the returnable containers on the server based on a number of returnable containers returned to the first party.

7. A system for managing physical distribution of products and returnable containers in which a first party ships at least one product packed in a returnable container to a second party upon a request of the second party to ship the products, and the second party sends back a number of the returnable containers to the first party, said system comprising;
a second party information-collecting section for receiving the request to ship at least one product and data indicating the number of the returnable containers returned from the second party;
a first party information-collecting section for receiving data indicating the number of the products shipped from the first party;
a product information-transmitting section for sending to the first party a product-shipping notice and the request to ship at least one product;
a returnable container information-transmitting section for sending to the second party a returnable container-returning notice;
an inventory information database-managing section for updating the inventory information databases of the at least one product and the returnable containers based on the received second party information and first party information; and
an inventory data-analyzing section for calculating the difference between actual inventories of the at least one product and the returnable containers and desired inventory levels of the at least one product and returnable containers, respectively, based on the inventory information databases of the products and the returnable containers, respectively, and for generating at least one of the product-shipping notice and the returnable container-returning notice when at least one of the products and the returnable containers actual inventories is below a predetermined value.

8. The system for managing physical distribution of products and returnable containers as set forth in claim 7, further comprising;
a second party information-inputting section for inputting second party information including the request to ship at least one product and data indicating the number of the returned returnable containers;
a second party information-transmitting section for sending the input second party information to said second party information-collecting section;
a returnable container-returning notice-receiving section for receiving said sent returnable container-returning notice; and
a returnable container-returning notice-displaying section for displaying said sent returnable container-returning notice.

9. The system for managing physical distribution of products and returnable containers as set forth in claim 7, further comprising;
a first party information-inputting section for inputting first party information including the number of the shipped at least one product;
a first party information-transmitting section for sending the input first party information to said first party information-collecting section;
a product-shipping notice-receiving section for receiving said sent product-shipping notice; and
a product-shipping notice-displaying section for displaying said sent product-shipping notice.

10. A system for managing physical distribution of products and returnable containers in which a first party sends products packed in returnable containers to a second party upon a request of the second party to ship the products and the second party sends back the returnable containers of the received products to the first party, said system comprising;
a server having inventory information databases of the products and the returnable containers;
at least one first party terminal; and
at least one second party terminal,
wherein said server, first party terminal and second party terminal are interconnected via a computer network, and said server is programmed to perform the steps of;
calculating the difference between an actual inventory of the products and a desired inventory level based on the request to ship at least one product and the inventory information database of the products;
sending a product-shipping notice to the first party via the computer network when the actual inventory of the at least one product is found to be below a first predetermined level;
calculating the difference between the actual inventory of the returnable containers and the desired inventory level based on the request to ship at least one product and the inventory information database of the returnable containers; and
sending said returnable container-returning notice to the second party via the computer network when the actual inventory of the returnable containers is found to be below a second predetermined level.

11. The system for managing physical distribution of products and returnable containers as set forth in claim 10, wherein said first party terminal is programmed to display a notice urging the first party to make available the products upon receiving said product-shipping notice.

12. The system for managing physical distribution of products and returnable containers as set forth in claim 10, wherein said second party terminal is programmed to display a notice urging the first party to send back the returnable container to the first party upon receiving said returnable container-returning notice.

13. The system for managing physical distribution of products and returnable containers as set forth in claim 10, wherein said second party terminal is programmed to transmit data input by the second party to the server indicating a number of the returned returnable containers, said first party terminal is programmed to transmit the data indicating a number of the shipped products input by the first party, and the server is programmed to renew the inventory information databases of the products and the returnable containers based on the received number of the returned returnable containers and the shipped products.

14. The system for managing physical distribution of products and returnable containers as set forth in claim 10, wherein said computer network is Internet.
